(19) United States
(12) Patent Application Publication
(10) Pub. No.: US 2025/0384788 A1
(43) Pub. Date: Dec. 18, 2025

(54) Gesture Playback System

(71) Applicant: Comcast Cable Communications, LLC, Philadelphia, PA (US)

(72) Inventors: Folake Gage, Frederick, MD (US); Bridget Coyne, New York, NY (US); Michael Cope, Reston, VA (US); Christopher Lehmann, Line Lexington, PA (US); Galen Trevor Gattis, Sunnyvale, CA (US)

(21) Appl. No.: 18/745,098

(22) Filed: Jun. 17, 2024

(51) Int. Cl. G09B 21/00; G06F 40/58

(52) U.S. Cl. CPC G09B 21/009; G06F 40/58

(57) ABSTRACT

Systems, apparatuses, and methods are described for providing sign language translations from content such as closed captioning content or transcribed audio or video content. In one aspect, the disclosure relates to providing sign language translations with adaptive speeds, such that the playback rates of the gestures for each of the sign language translations are optimally synchronized with the content. The system may receive audio content data and access the necessary data to translate the data into a sequence of sign language gestures associated with the sign language translation of the data. By determining an allocated duration for each gesture in the sequence and sending that data in a consumable format, the system may calculate a gesture playback rate, which will be used to generate renderings of the gestures in synchronization with the audio content data.

### BACKGROUND

Subtitles and captioning for media content, both live or pre-recorded, are widely available and allow viewers to read the text of spoken language. Some hearing-impaired individuals are able to utilize these features to understand and enjoy the content. However, subtitles may be insufficient for others. For example, spoken English is grammatically different from American Sign Language (ASL). The hearing-impaired individual, whose first language is ASL, may not be fluent in English and may have difficulty understanding the content from reading the subtitles of spoken English. Thus, access to signed translation is useful, necessary, and important. Signed translation in media content today is traditionally performed by a live interpreter. However, there is a need for an automated and scalable process to provide accurate signed translation media content without live interpreters.

### SUMMARY

The following summary presents a simplified summary of certain features. The summary is not an extensive overview and is not intended to identify key or critical elements.

Systems, apparatuses, and methods are described for a gesture playback system that creates sign language translations from audio inputs, closed captioning, or other data sources. The disclosed technology automates the process of converting captioning into visually represented sign language translations for content viewers. Further, the gesture playback system displays representations of the sign language translation, which are in synchronization with the provided audio and/or captioning. For example, the gesture playback system may access audio and/or closed caption content in the media and translate that content into grammatically accurate American Sign Language (ASL) translations. This may be accomplished by defining an algorithm or training a machine learning program that divides the audio and/or closed caption content into text segments. The algorithm may synchronize each text segment with the ASL translation through time analysis such that each text segment and the ASL translation plays at the appropriate “start time” and with the appropriate “duration.” In some instances, the audio and/or closed caption test string may comprise ten words and require a translation, equivalent to five sign language gestures to represent the text. With the objective of displaying the sign language gestures during the time the associated audio is spoken in the content, or closed caption text is presented, the gesture playback system may determine the appropriate and optimal timing, pace, rate or spacing out of the translated gesture to be synchronized with the presentation or display of the corresponding closed caption text. The input speech data is not limited to closed captioning data or audio data, but may come from any source associated with the content. The gesture playback system also provides the advantage of scalability by relying on an automatic process of extracting data from content and converting the data into a sign language translation. The sign language translation may then be visually represented by an avatar displayed on screen in sync with the content.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows a simplified block diagram illustrating an overview of exemplary components and entities that may interact with the platform at various points during system utilization, in accordance with one embodiment.

FIG. 4 is a flow chart showing an example method for generating and displaying renderings of each gesture in accordance with adjusted gesture playback rate.

FIG. 5 shows an example of extracting information such as caption, start time, and duration, from input data.

FIG. 6 shows an example of translating information (e.g., stored information, sent information) to a sequence of sign language gestures.

FIG. 7 shows an example of determining an allocated duration for each gesture.

FIG. 8 shows an example of data in consumable format.

FIG. 9 shows an example of predetermined gesture time.

FIG. 10 shows an example embodiment of when the gesture playback rate is greater than the minimum playback threshold.

FIG. 11 shows an example embodiment of when the playback rate is less than the minimum playback threshold.

FIG. 12 shows an example embodiment of displaying a visual rendering of the sequence of sign language gestures in accordance with the adjusted gesture playback rate.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

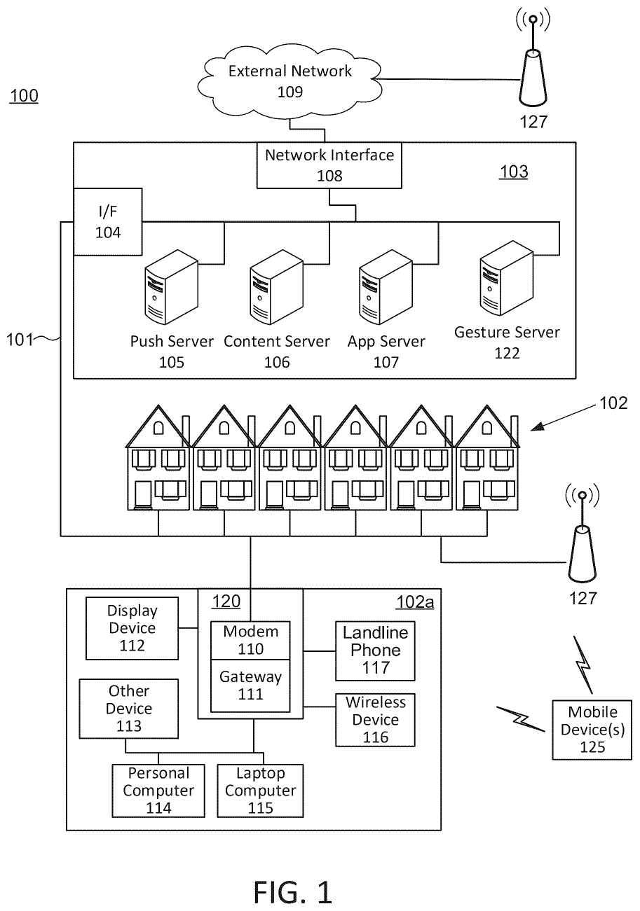

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network. For example, the one or more mobile devices 125 may comprise a smartphone that is used to view content (e.g., an audio-video stream that comprises data indicating audio content, transcription content, and subtitle/captioning content) that is transmitted to the smartphone via the one or more external networks 109, using a connection that is established between the smartphone and one or more of the server 105-107 and gesture server 122.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and gesture server 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the gesture server 122 (described below), additional push, content, and/or application servers, and/or other types of servers. Although shown separately, the push server 105, the content server 106, the application server 107, the gesture server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The one or more mobile devices 125, one or more of the devices in the premises 102a, and/or other devices may receive, store, output, and/or otherwise use assets. An asset may comprise a video, a game, one or more images, software, audio, text, webpage(s), and/or other content.

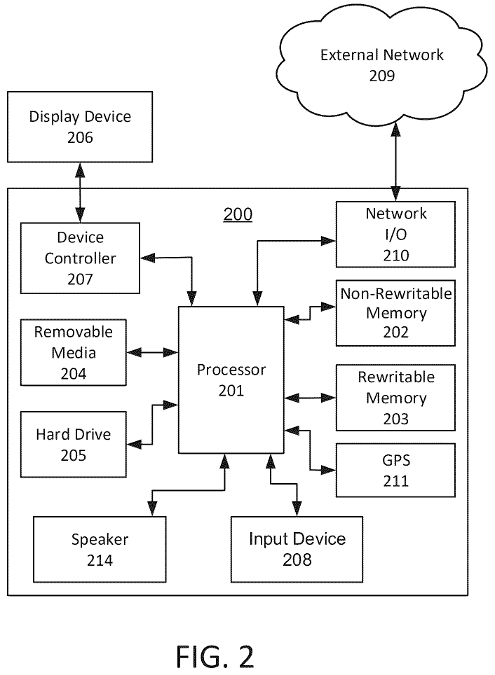

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., gesture server 122). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random-access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

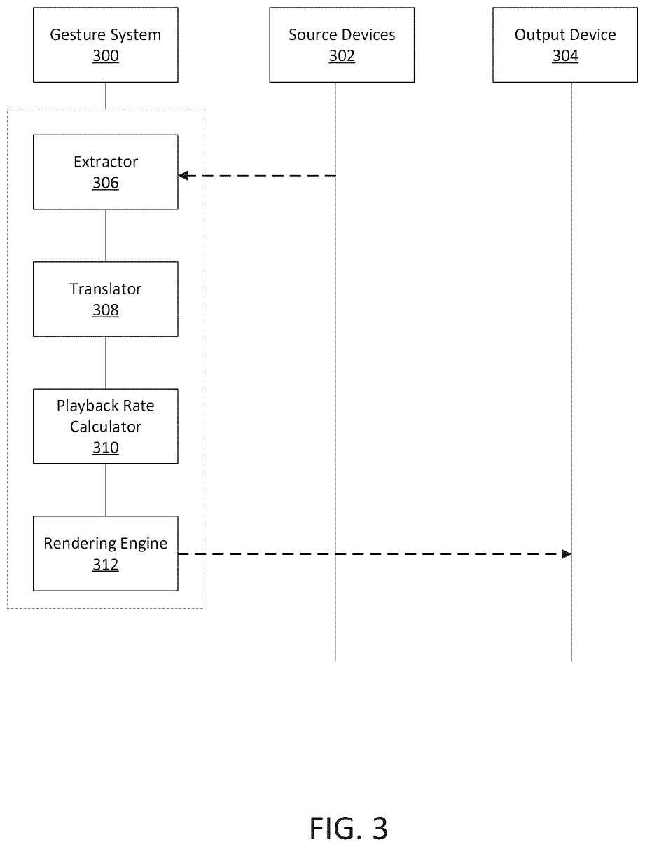

FIG. 3 shows a simplified block diagram illustrating an overview of exemplary components and entities that may interact with the platform at various points during system utilization, in accordance with one embodiment. Extractor 306, translator 308, playback rate calculator 310, and rendering engine 312 are some of the example elements within the gesture system 300. These elements may be in one physical device. Additionally, or alternatively, some of the elements may be remote. The extractor 306 may receive data (e.g., closed caption data, audio data, content data, other data representing speech) from the source devices 302 (e.g., a database that contains pre-recorded audio tracks, subtitles, captions, translations, closed caption data from pre-authored content or live transcription, etc.). The extractor 306 may extract information (e.g., caption text, start time information, end time information, or duration) from the received data. The translator 308 may, for example, translate the closed caption data, audio data, or other data representing speech, to a sequence of sign language gestures. In another example, the audio data, either directly or by converting the speech to text, may be used to translate the speech into a sequence of sign language gestures. These gestures may be representative of sign language translations. The playback rate calculator 310 may calculate timings for each gesture by taking the allocated duration of the data and dividing it among the number of gestures. The playback rate calculator 310 may determine the allocated duration per gesture. The rendering engine 312 may receive output data from the playback rate calculator 310. The output data may be sent in a consumable format. The rendering engine 312 may generate the sequence of sign language gestures, synchronized with the gesture playback rate. The gesture server 122 may send the sequence of sign language gestures to the output device 304. The output device 304 may be a display device, a television, a personal mobile device, smart phone, etc. The gesture system 300 may also be gesture playback system or any other system that is able to perform these steps. The gesture system 300 may also include the gesture server 120.

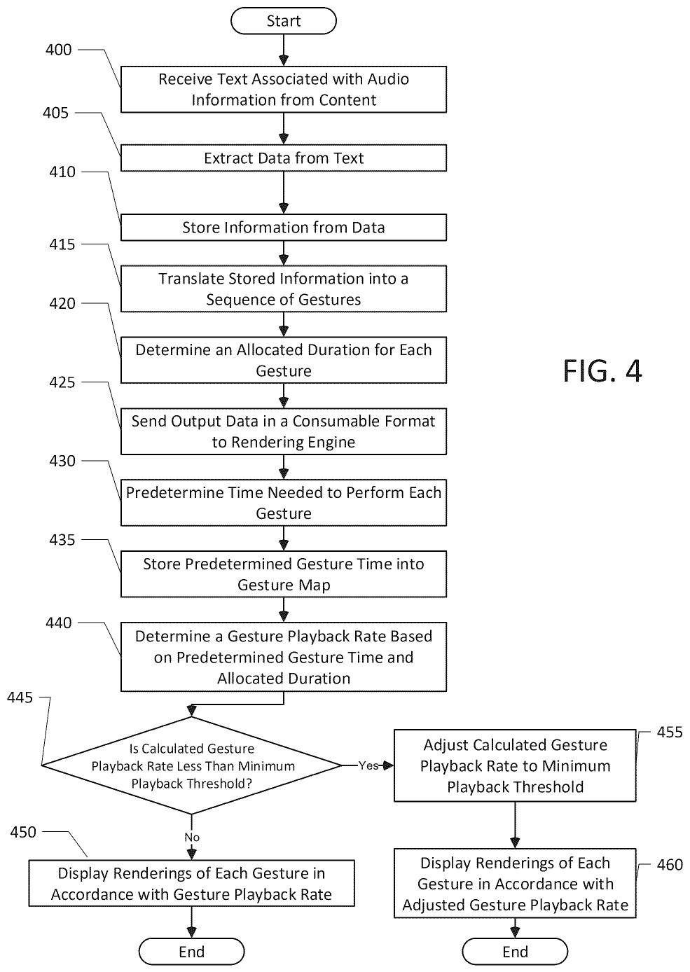

FIG. 4 is a flow chart showing an example method for generating and displaying renderings of each gesture translation in accordance with the adjusted gesture playback rate. Any of the computing devices shown in FIGS. 1-2 (e.g., the one or more mobile devices 125 and/or the gesture server 122) and/or any other computing devices described herein may be used to implement any of the operations described herein.

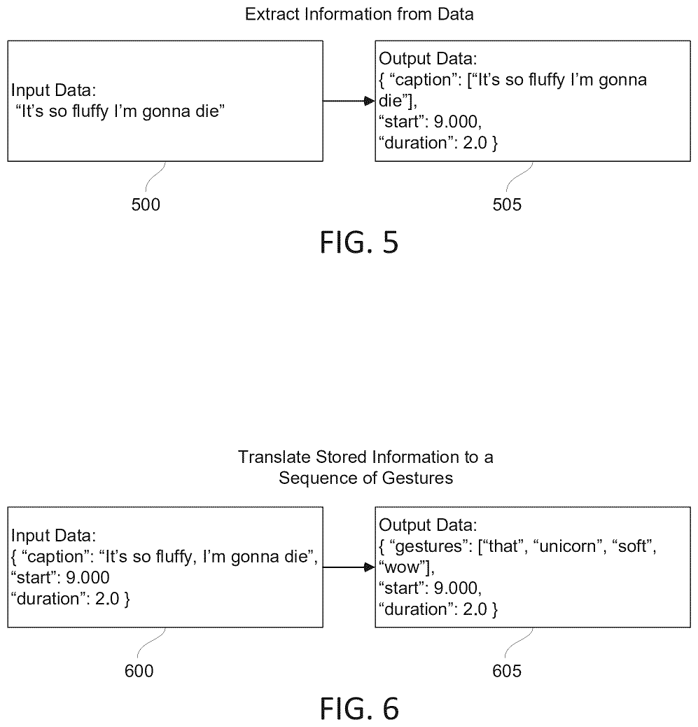

At step 400, the gesture system 300 receives text data associated with video content. The text may be subtitles or closed captioning from pre-authored content or live content, transcribed in real-time. For example, pre-authored content could be a movie or tv show, which already includes closed captions. Live content could be a live sports or news show. Closed captions are typically in the same language as the original audio content. Subtitles are a form of captioning used to translate the audio dialogue content from one language into another. The received text data may be closed caption data or subtitle data or a transcription data of the audio dialogue from the content could come from a database, a sidecar file data or directly from the stream itself. The text data may include the text, start time, end time, or duration. For example, the received text data could look like the input data 500 in FIG. 5.

At step 405, the gesture system 300 extracts data from the text data. The extracted data may include the text, start time, and end time, or duration of a segment of audio dialogue from content. For example, the extracted data could look like output data 505 in FIG. 5. If the received text data of the segment of audio dialogues is “It's so fluffy I'm gonna die,” the gesture system 300 extracts information such as start time at 9 seconds, and the duration at 2 seconds, as depicted in output data 505 of FIG. 5. The gesture system 300 may extract additional information or any additional combination of information such as an intensity of each word from the audio or dialogue content. The intensity could be based on the context of the rest of the segment of audio dialogue content such as the facial expression of the speaker. The intensity could be measured by a percentage, expression level, an emotional scale, or some other type of classification or rating or scoring system. Another example of extracted information may include the relative volume of each word from the segment of audio dialogue content.

At step 410, the gesture system 300 may store or send the information that was extracted from the text data. The extracted information of the associated segment of audio dialogue content such as the start time, duration, end time, intensity, volume, etc., may be stored in memory. By storing the information, the gesture system 300 may have access to the information at another time. Additionally, or alternatively, storing the information may be optional and not required.

At step 415, the gesture system 300 translates the information into a sequence of sign language gestures. The translator 308 of the gesture system 300 may be used to translated the information into the sequence of sign language gestures. For example, the input data 600 in FIG. 6 shows information and the output 605 in FIG. 6 shows the translation of the caption data. The text data or caption could say: “It's so fluffy, I'm gonna die.” The caption could have a gesture translation: “that” “unicorn” “soft” “wow.” The caption could also be in various different languages such as Spanish, Korean, Chinese, Portuguese, etc. The gesture system 300 may actively translate the text or may receive a translation from a database. The gesture translation could be in, for example, American Sign Language (ASL), British Sign Language (BSL), Australian Sign Language (Aulan), etc.

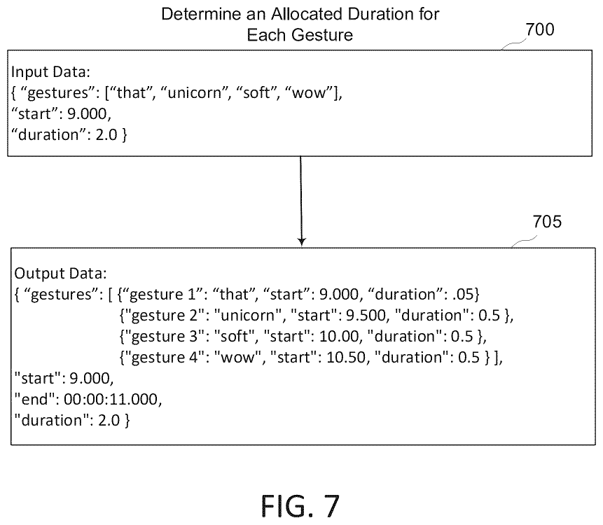

At step 420, the gesture system 300 determines an allocated duration for each gesture. The allocated duration may be the length of time or period of time that each gesture may have for performing the gesture. This information may be necessary in determining the gesture playback rate in the later steps. This ensures that each gesture is synchronized with the duration of the original text segment. The allocated duration may be calculated by dividing a segment duration of a text segment with a total number of gestures in the sequence of sign language gestures. The segment duration may be the difference between the start time of the text segment and the end time of the text segment. For example, output data 705 of FIG. 7 breaks down each gesture from the input data 700. There are four translated gestures shown in input data 700 with a duration of two (2.0) seconds. Two seconds divided by four gestures equals a 0.5 second duration for each translated gesture. In this example, each of the translated gestures have an allocated duration of 0.5 seconds. The output data for determining allocated durations of each translate gesture may also include a start time for each gesture in accordance with the duration of each gesture and an overall start time, end time, and duration for the full segment.

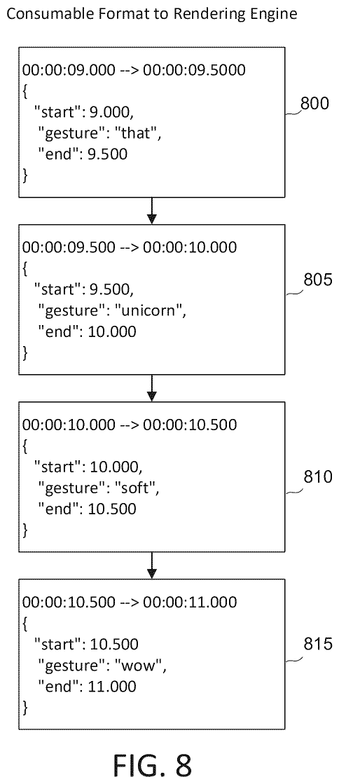

At step 425, the gesture system 300 sends output data in a consumable format to the rendering engine 312. For example, the output data may be the data shown in FIG. 7, which may be converted into the consumable format as shown in FIG. 8. At 800, the consumable format may include the start time of the text segment (9.0) as the start time for the first gesture, “that,” and the end time associated with “that.” The end time for “that” may be determined by adding the allocated duration of 0.5, which was determined in step 420, to the start time 9.0. This provides the end time for “that” of 9.5. At 805, the next gesture, “unicorn,” has a corresponding start time of 9.5, which is based on the end time of the previous gesture. The next end time for the next gesture “unicorn” may be determined by adding the allocated duration of 0.5 to 9.5, which equals 10.0. The process continued to repeat itself for each gesture. At 810, the next gesture, “soft,” has the start time, which is the end time of the previous gesture “unicorn” at 10.0. The allocated duration for “soft,” determined in step 420, is 0.5. By adding the start time of 10.0 with the allocated duration, 0.5, the end time for “soft” may be determined to be 10.5. At 815, the next gesture, “wow,” has the start time of the previous end time for “soft,” which is 10.5. The allocated duration for “wow,” determined in step 420, is 0.5. By adding the start time of 10.5 with the allocated duration, 0.5, the end time for “wow” may be determined to be 11.0. This is an example of the output data from step 420, converted into the consumable format for the rendering engine 312. In this example, the output data may be sent using a .vtt file. The rendering engine 312 may be a software component that provides the visual representations or renderings for each gesture.

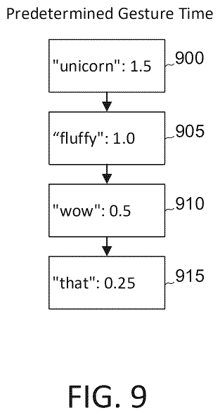

At step 430, the gesture system 300 receives the predetermined time needed to perform each gesture. For example, FIG. 9 shows at 900, the “unicorn” gesture may be predetermined to be 1.5 seconds. At 905, the “fluffy” gesture is predetermined to be 1 second. At 910, the “wow” gesture is predetermined to be 0.5 seconds. At 915, the “that” gesture is predetermined to be 0.25 seconds. The predetermined gesture times may be determined by a variety of sources such as a machine learning algorithm that uses speech recognition of the original audio dialogue and determines the associated predetermined time of the translated gesture for the gesture to be synchronized with the audio dialogue. The predetermined gesture times may be determined by a database from the content source, which may include data associated with generating digital files of subtitles by translators. These are only a few examples out of the many different means of obtaining this information. Different methods may be used for predetermining the timing of each gesture to optimally match the pace and tone of the original audio content.

At step 435, the gesture system 300 may store or send the predetermined gesture times for each translated gesture to a gesture map. The gesture map may allow the predetermined gestures to be accessed and used for further calculations.

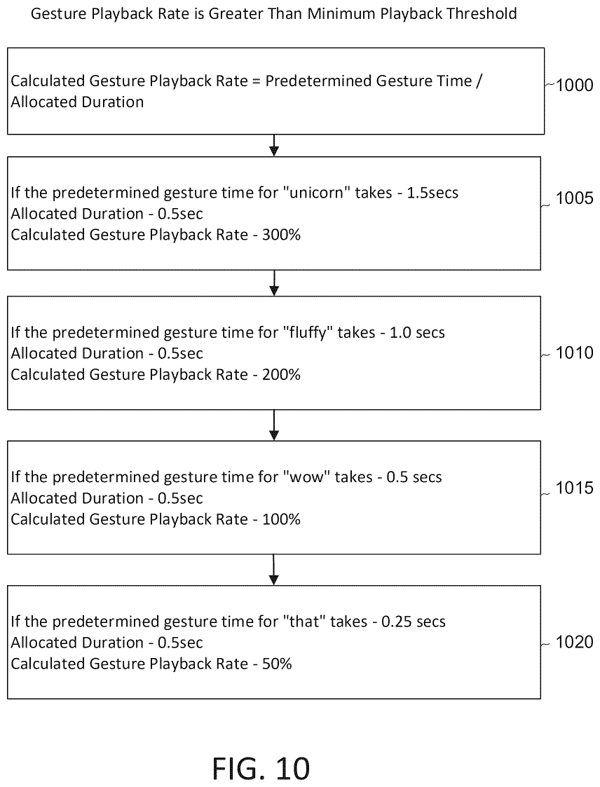

At step 440, the playback rate calculator 310 of the gesture system 300 calculates a gesture playback rate based on the predetermined gesture times and the allocated durations of each translated gesture. The gesture playback rate may be the rate in which each gesture is played to the content viewer. The gesture playback rate may be calculated in a variety of ways. In one embodiment, for example, the gesture playback rate calculator may use a formula (gesture function). The formula may determine the gesture playback rate by dividing the predetermined gesture time by the allocated time. FIG. 10 depicts an example embodiment. Based on step 430 and 900, the predetermined gesture time for “unicorn” is 1.5 seconds. Based on step 420, the allocated duration is 0.5. Thus, the calculated gesture playback rate at 1005 can be determined by 1.5/0.5=300%. The calculations may be repeated for each gesture. Based on step 430 and 905, the predetermined gesture time for “fluffy” is 1.0 seconds. Based on step 420, the allocated duration is 0.5. The calculated gesture playback rate at 1010 can be determined by 1.0/0.5=200%. Based on step 430 and 910, the predetermined gesture time for “wow” is 0.5 seconds. Based on step 420 and 915, the allocated duration is 0.25. The calculated gesture playback rate at 1015 can be determined by 0.5/0.5=100%. Lastly, based on step 430, the predetermined gesture time for “that” is 0.5 seconds. Based on step 420, the allocated duration is 0.5. The calculated gesture playback rate at 1020 can be determined by 0.5/0.5=100%.

At decision step 445, the gesture system 300 determines whether the calculated gesture playback rate is less than the minimum playback threshold. This decision step 445 may exist to provide a way to prevent or avoid slow motion gestures. In the case that the calculated gesture playback rate from step 440 is below a minimum playback threshold and is played at that gesture playback rate, this would mean that the gesture would be played in slow motion. This would be a yes in the decision step 445 and would proceed to step 455. If the gesture system 300 determines that the calculated gesture playback rate is not less than, or in other words, is greater than or equal to the minimum playback threshold, then the next step is step 450.

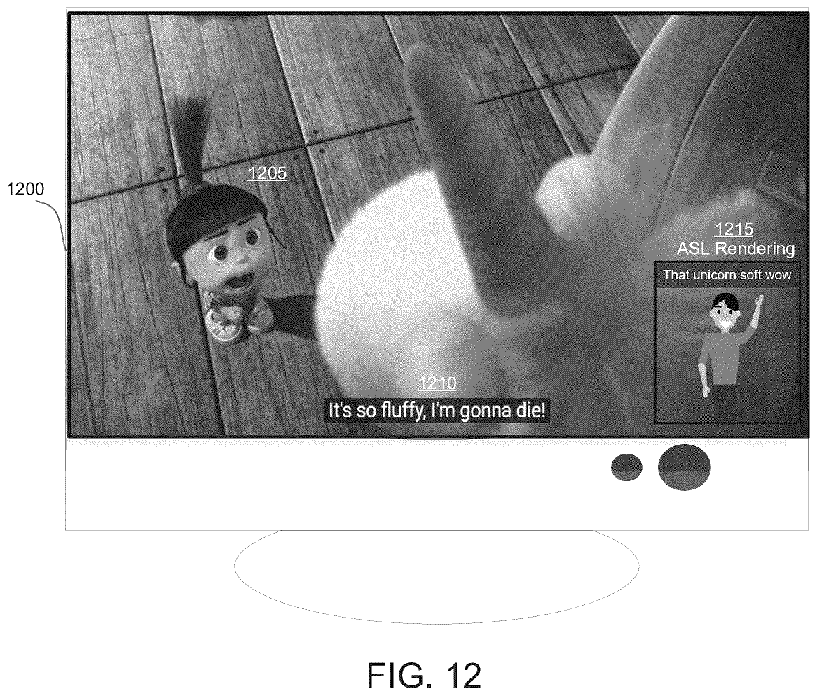

At step 450, the gesture server 122 sends the renderings of each gesture to be displayed in accordance with the gesture playback rate, based on step 440. The gesture server 122 may obtain the renderings of each gesture from the rendering engine. The renderings may be displayed on a content player such as a television, mobile device, or smart phone. The renderings may be manifested or represented by an avatar. The avatar may be displayed as an overlay in the bottom corner of the content player, synchronized with the visual and audio content. For example, FIG. 12 shows an embodiment of a content player 1200, displaying a scene from a movie with the closed caption text and the ASL rendering. The character 1205 is speaking. The closed captioning 1210 of the audio segment is being translated in the ASL as shown by the avatar 1215.

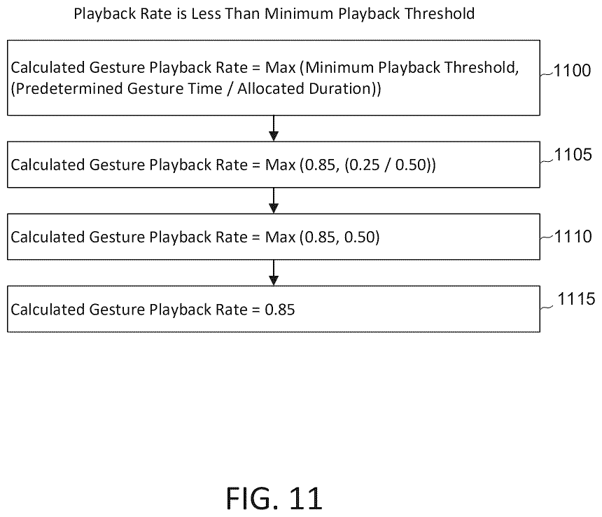

At step 455, the gesture system 300 may have determined that the calculated gesture playback rate is less than the minimum playback threshold. This would be an indication that the gesture would be played in slow motion. The goal of the gesture system may be to ensure that the gestures are played at the optimal speed such that the gesture may be most synchronized with the corresponding audio content and closed caption text. In order to do so, the gesture system 300 may adjust the calculated gesture playback rate to the minimum playback threshold. The adjustment may be accomplished by using a maximum function. By comparing the value of the minimum playback threshold with the calculated gesture playback rate, the greater of the two values will be the new gesture playback rate for the respective gesture. For example, FIG. 11 at 1100 portrays the maximizing function. As shown at 1105, if the minimum playback threshold for a gesture was 0.85, and the calculated gesture playback rate for that gesture was 0.5, which may have been determined in step 450 by dividing the predetermined gesture time (0.25) by the allocated duration (0.50), the resulting gesture playback rate would be 0.50 at shown at 1110. By comparing minimum playback threshold (0.85) and the calculated gesture playback rate (0.50), the maximum value out of the two values is the minimum playback threshold (0.85). As shown at 1115, the new gesture playback rate for that gesture will be 0.85.

At step 460, the gesture server 122 sends the renderings of each gesture to be displayed in accordance with the adjusted gesture playback rate, based on step 455. The gesture server 122 may obtain the renderings of each gesture from the rendering engine. The renderings may be displayed on a content player such as a television, mobile device, or smart phone. The renderings may be manifested or represented by an avatar. The avatar may be displayed as an overlay in the bottom corner of the content player, synchronized with the visual and audio content. For example, FIG. 12 shows an embodiment of a content player 1200, displaying a scene from a movie with the closed caption text and the ASL rendering. The character 1205 is speaking. The closed captioning 1210 of the audio segment is being translated in the ASL as shown by the avatar 1215.

FIG. 5 shows an example of extracting information such as caption, start time, and duration, from input data. Input data 500 may be the received text data, in relation to step 400 of FIG. 4, and the extracted data could look like output data 505, in relation to step 405 of FIG. 4. If the received text data of the segment of audio dialogues is “It's so fluffy I'm gonna die,” the gesture system 300 may extract information such as start time at 9 seconds, and the duration at 2 seconds, as depicted in output data 505 of FIG. 5. The gesture system 300 may extract additional information or any additional combination of information such as an intensity of each word from the audio or dialogue content. The intensity could be based on the context of the rest of the segment of audio dialogue content such as the facial expression of the speaker. The intensity could be measured by a percentage, expression level, an emotional scale, or some other type of classification or rating or scoring system. Another example of extracted information may include the relative volume of each word from the segment of audio dialogue content.

FIG. 6 shows an example of translating information (e.g., stored information, sent information) into a sequence of sign language gestures. This figure may correspond to step 415 of FIG. 4. The input data 600 may show information and the output 605 shows the translation of the caption data. The text data or caption could say: “It's so fluffy, I'm gonna die.” The caption could have a gesture translation: “that” “unicorn” “soft” “wow.” The caption could also be in various different languages such as Spanish, Korean, Chinese, Portuguese, etc. The gesture system 300 may actively translate the text using the translator 308 or may outsource the translation and receive a translation from a database. The gesture translation could be in, for example, American Sign Language (ASL), British Sign Language (BSL), Australian Sign Language (Aulan), etc.

FIG. 7 shows an example of determining an allocated duration for each gesture. The allocated duration may be calculated by dividing a segment duration of a text segment with a total number of gestures in the sequence of sign language gestures. The segment duration may be the difference between the start time of the text segment and the end time of the text segment. The output data 705 breaks down each gesture from the input data 700. There are four translated gestures shown in input data 700 with a duration of two (2.0) seconds. Two seconds divided by four gestures equals a 0.5 second duration for each translated gesture. In this example, each of the translated gestures have an allocated duration of 0.5 seconds. The output data for determining allocated durations of each translate gesture may also include a start time for each gesture in accordance with the duration of each gesture and an overall start time, end time, and duration for the full segment. This example embodiment may correspond to step 420 of FIG. 4. The allocated duration may be the length of time or period of time that each gesture may have for performing the gesture. This information may be necessary in determining the gesture playback rate in the later steps. This ensures that each gesture is synchronized with the duration of the original text segment.

FIG. 8 shows an example of data in consumable format. The output data may be the data 705 shown in FIG. 7, which may be converted into the consumable format as shown in FIG. 8. This example embodiment corresponds to step 425. The gesture system 300 may send output data in a consumable format to the rendering engine 312. At 800, the consumable format may include the start time of the text segment (9.0) as the start time for the first gesture, “that,” and the end time associated with “that.” The end time for “that” may be determined by adding the allocated duration of 0.5, which was determined in step 420, to the start time 9.0. This provides the end time for “that” of 9.5. At 805, the next gesture, “unicorn,” has a corresponding start time of 9.5, which is based on the end time of the previous gesture. The next end time for the next gesture “unicorn” may be determined by adding the allocated duration of 0.5 to 9.5, which equals 10.0. The process continued to repeat itself for each gesture. At 810, the next gesture, “soft,” has the start time, which is the end time of the previous gesture “unicorn” at 10.0. The allocated duration for “soft,” determined in step 420, is 0.5. By adding the start time of 10.0 with the allocated duration, 0.5, the end time for “soft” may be determined to be 10.5. At 815, the next gesture, “wow,” has the start time of the previous end time for “soft,” which is 10.5. The allocated duration for “wow,” determined in step 420, is 0.5. By adding the start time of 10.5 with the allocated duration, 0.5, the end time for “wow” may be determined to be 11.0. This is an example of the output data from step 420, converted into the consumable format for the rendering engine 312. In this example, the output data may be sent using a .vtt file. The rendering engine 312 may be a software component that provides the visual representations or renderings for each gesture.

FIG. 9 shows an example of predetermined gesture time. At 900, the “unicorn” gesture may be predetermined to be 1.5 seconds. At 905, the “fluffy” gesture is predetermined to be 1 second. At 910, the “wow” gesture is predetermined to be 0.5 seconds. At 915, the “that” gesture is predetermined to be 0.25 seconds. The predetermined gesture times may be determined by a variety of sources such as a machine learning algorithm that uses speech recognition of the original audio dialogue and determines the associated predetermined time of the translated gesture for the gesture to be synchronized with the audio dialogue. The predetermined gesture times may alternatively be determined by a database from the content source, which may include data associated with generating digital files of subtitles by translators. These are only a few examples out of the many different methods of obtaining this information. Different methods may be used for predetermining the timing of each gesture to optimally match the pace and tone of the original audio content. The predetermined gesture time 900 is an example embodiment that may correspond to step 430 in FIG. 4.

FIG. 10 shows an example embodiment of when the gesture playback rate is greater than the minimum playback threshold. The example embodiment corresponds to step 440 and 445 of FIG. 4, in the case that the calculated gesture playback rate is not less than the minimum playback threshold. No additional maximum function would need to be performed as provided in step 455 of FIG. 4. The gesture system 300 would maintain the calculated gesture playback rate and continue to display the renderings of the sequence of sign language gestures accordingly.

For example, at 1000, the calculated gesture playback rate is calculated by dividing predetermined gesture time by the allocated duration. Based on step 430 and 900, the predetermined gesture time for “unicorn” is 1.5 seconds. Based on step 420, the allocated duration is 0.5. Thus, the calculated gesture playback rate at 1005 can be determined by 1.5/0.5=300%. The calculations may be repeated for each gesture. Based on step 430 and 905, the predetermined gesture time for “fluffy” is 1.0 seconds. Based on step 420, the allocated duration is 0.5. The calculated gesture playback rate at 1010 can be determined by 1.0/0.5=200%. Based on step 430 and 910, the predetermined gesture time for “wow” is 0.5 seconds. Based on step 420 and 915, the allocated duration is 0.25. The calculated gesture playback rate at 1015 can be determined by 0.5/0.5=100%. Lastly, based on step 430, the predetermined gesture time for “that” is 0.5 seconds. Based on step 420, the allocated duration is 0.5. The calculated gesture playback rate at 1020 can be determined by 0.5/0.5=100%. Since all of these calculated gesture playback rates may be determined to be above the minimum playback threshold, step 445 would proceed to step 450 to display the renderings of each gesture in accordance with the calculated gesture playback rates.

There may be a situation where the content or video play has a different rate. For example, the content player may currently be at 200%. A client or viewer may have selected to watch the video at 200%. The final gesture playback rate may be determined by multiplying the content player rate with the calculated gesture playback rate. In the case that the calculate gesture playback rate for “fluffy” is 200%, the final gesture playback rate may be calculated by multiplying the 200% (content player rate) with 200% (calculated gesture playback rate), which equals 400%. The final gesture playback rate may be adjusted to 400%. For the translated gesture, “that,” the calculated gesture playback rate may be 85%. Therefore, the final gesture playback rate may be determined by 85%*200% which results in 170%. The final gesture playback rate may be adjusted to 170% for the “that” gesture. These adjustments for the final gesture playback rate may be necessary to provide synchronizations that are on pace or optimally aligned with the rate in which the content is being played and the closed caption text is being displayed.

FIG. 11 shows an example embodiment of when the playback rate is less than the minimum playback threshold. At step 455, the gesture system 300 may have determined that the calculated gesture playback rate is less than the minimum playback threshold. This would be an indication that the gesture would be played in slow motion. The goal of the gesture system may be to ensure that the gestures are played at the optimal speed such that the gesture may be most synchronized with the corresponding audio content and closed caption text. In order to do so, the gesture system 300 may adjust the calculated gesture playback rate to the minimum playback threshold. The adjustment may be accomplished by using a maximum function. By comparing the value of the minimum playback threshold with the calculated gesture playback rate, the greater of the two values will be the new gesture playback rate for the respective gesture. For example, FIG. 11 at 1100 portrays the maximizing function. As shown at 1105, if the minimum playback threshold for a gesture was 0.85, and the calculated gesture playback rate for that gesture was 0.5, which may have been determined in step 450 by dividing the predetermined gesture time (0.25) by the allocated duration (0.50), the resulting gesture playback rate would be 0.50 at shown at 1110. By comparing minimum playback threshold (0.85) and the calculated gesture playback rate (0.50), the maximum value out of the two values is the minimum playback threshold (0.85). As shown at 1115, the new gesture playback rate for that gesture will be 0.85.

FIG. 12 shows an example embodiment of displaying a visual rendering of the sequence of sign language gestures in accordance with the adjusted gesture playback rate. This example embodiment corresponds to steps 450 or 460 of FIG. 4. FIG. 12 portrays a content player 1200, displaying a scene from a movie with the closed caption text and the ASL rendering. The character 1205 is speaking. The closed captioning 1210 of the audio segment is being translated in the ASL as shown by the avatar 1215.

In an embodiment, this gesture system may be requested by a client, viewer, or a user, by selecting the option for sign language translation for a variety of desired content such as audio dialogue, podcast, movie, film, streaming, television shows, series, targeted advertisement, news show, live content, etc. A client may select the desired speed to watch the content and the synchronized sign language translation. The gesture system may provide adaptive speeds for the gestures for the appropriate sign language translation that are optimally synchronized with the closed captioning segment or video frame segment or audio dialogue in real time. The gesture system may be in accordance with the respective standards for closed captioning and translations for each country or region.

According to various embodiments, sign language translation may be performed by a local server within the gesture system. Additionally, sign language translation may also be performed by an external server that the gesture system outsources to a third-party sign language translation server. The sign language translation may be based on the data of pre-authored content, or it may be generated by artificial intelligence or machine learning algorithms or it may be based directly on automatic speech recognition. The sign language translation process may alternatively be manually determined by sign-language experts. The translation process may be performed by any number of combinations and variations. With access to extensive meta data, the translation may be performed optimally for higher accuracy. For example, the context of the content such as the genre of the video, the machine learning would be trained over time and may continue to improve in accuracy of the sign language translation and the quality of the sign language translation. In another example, the sign language translation process may be able to point to specific items within the context of the video content to improve and optimize the quality of the sign language translation. The context of the translation may also utilize the content data based on prior and future points in time of the content.

The representation of the gestures may be displayed and positioned anywhere on the screen. The positioning of the representation may be automated or may be personalized and selected by the client or user. For example, the representation may be positioned at any corner of the screen, it may be overlaid next to the closed caption text or it may be by click-and-drag to anywhere on the screen. The size or dimension of the representation may be customized by the client or by the content provider or by the advertising agency, which may vary by the content type. The user may build their own desired avatar. The gestures may be manifested and automated by a graphical representation such as an avatar that may be virtually generated by artificial intelligence. The user may select a locally generated, on-screen sign language avatar based on a number of different preferences such as the color, gender, race, three-dimensional (3D) animation, two-dimensional (2D) animation, cartoons, hair, clothing, a Disney princess, a marvel character, actor or actress, etc. The user may personalize the avatar to their liking. Those skilled in the art will recognize variations on such combinations of and additions to the graphical representation of the gestures.

The following are examples of some definitions: Real time—live streaming video content or live television; Closed captions—detailed time coded text that appears at the proper time while watching media; Live transcription—real time text on screen that is computer generated during a live program and may not be entirely accurate; Visual caption—some form of pre generated signed translation (i.e. clip of avatar signing “hello”); 808 Standard—new standard to be defined for media content; ASL gesture Identifier—identifier tied to specific visual caption.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
accessing, by one or more computing devices, audio information associated with content;
translating the audio information into a sequence of sign language gestures;
determining an allocated duration for each gesture in the sequence of sign language gestures;
determining, based on the allocated duration for each gesture, a gesture playback rate; and
providing, for output, data comprising the sequence of sign language gestures at the determined gesture playback rate.

2. The method of claim 1, further comprises storing a text segment associated with the audio information, a start time associated with the text segment, and a duration associated with the text segment.

3. The method of claim 1, wherein the data further comprises:
a start time associated with the allocated duration of each gesture; and
an end time associated with the allocated duration of each gesture.

4. The method of claim 1, wherein the determining further comprises:
sending a text segment associated with the audio information;
accessing a start time associated with the text segment and a segment duration associated with the text segment; and
determining, for each gesture, the allocated duration by dividing the segment duration with a total number of gestures in the sequence of sign language gestures.

5. The method of claim 1, further comprises:
determining, for each gesture, the gesture playback rate by dividing a predetermined gesture time with the allocated duration.

6. The method of claim 1, further comprises:
determining, for each gesture, the gesture playback rate that is less than a minimum playback threshold; and
adjusting, based on the determination, the gesture playback rate to be equivalent to the minimum playback threshold.

7. The method of claim 1, further comprises:
determining, for each gesture, the gesture playback rate by dividing a predetermined gesture time with the allocated duration; and
determining an adjusted gesture playback rate based on a maximum value between a minimum playback threshold and the determined gesture playback rate.

8. The method of claim 1, further comprises:
receiving a content player rate;
determining that the content player rate is above a normal rate; and
determining, an adjusted gesture playback rate by multiplying the content player rate with the gesture playback rate.

9. The method of claim 1, further comprises the sequence of sign language gestures associated with Sign Language.

10. The method of claim 1, further comprises:
determining, based on a context of a text segment, an intensity associated with each gesture.

11. The method of claim 1, wherein the translating further comprises training a machine learning model to translate the audio information to the sequence of sign language gestures.

12. A method comprising:
accessing, by one or more computing devices, audio information associated with content;
translating the audio information into a sequence of sign language gestures;
determining an allocated duration for each gesture in the sequence of sign language gestures;
determining, based on the allocated duration for each gesture, a slow gesture playback rate; and
providing, for output, data comprising the sequence of sign language gestures at the slow gesture playback rate.

13. The method of claim 12, further comprises:
receiving a minimum playback threshold, wherein the slow gesture playback rate is less than the minimum playback threshold; and
adjusting, the slow gesture playback rate to be equivalent to the minimum playback threshold.

14. The method of claim 12, further comprises:
determining, for each gesture, the slow gesture playback rate by dividing a predetermined gesture time with the allocated duration, wherein a minimum playback threshold is greater than the slow gesture playback rate; and
adjusting, based on the determination, the slow gesture playback rate to be equivalent to the minimum playback threshold.

15. The method of claim 12, further comprises sending a text segment associated with the audio information, a start time associated with the text segment, and a duration associated with the text segment.

16. The method of claim 12, wherein the data further comprises:
a start time associated with the allocated duration of each gesture; and
an end time associated with the allocated duration of each gesture.

17. A method comprising:
accessing, by one or more computing devices, audio information associated with content;
translating the audio information into a sequence of sign language gestures;
determining an allocated duration for each gesture in the sequence of sign language gestures; and
providing, for output, data comprising the sequence of sign language gestures according to a gesture playback rate and a content player rate.

18. The method of claim 17, further comprises:
determining, for each gesture, the gesture playback rate by dividing a predetermined gesture time with the allocated duration;
receiving the content player rate, wherein the content play rate is above a normal rate; and
determining, an adjusted gesture playback rate by multiplying the content player rate with the gesture playback rate.

19. The method of claim 17, further comprises sending a text segment associated with the audio information, a start time associated with the text segment, and a duration associated with the text segment.

20. The method of claim 17, wherein the data further comprises:
a start time associated with the allocated duration of each gesture; and
an end time associated with the allocated duration of each gesture.
